(19) United States
(12) Patent Application Publication
(10) Pub. No.: US 2022/0118391 A1
(43) Pub. Date: Apr. 21, 2022

(54) HONEYCOMB STRUCTURE AND EXHAUST GAS PURIFYING DEVICE

(71) Applicant: NGK INSULATORS, LTD., Nagoya-City (JP)

(72) Inventors: Shuichi ICHIKAWA, Nagoya-City (JP); Takuya ISHIHARA, Tsushima-City (JP); Yukio MIYAIRI, Nagoya-City (JP); Masaaki MASUDA, Nagoya-City (JP)

(73) Assignee: NGK INSULATORS, LTD., Nagoya-City (JP)

(21) Appl. No.: 17/646,742

(22) Filed: Jan. 3, 2022

Related U.S. Application Data
(63) Continuation of application No. PCT/JP2020/018584, filed on May 7, 2020.

(30) Foreign Application Priority Data
Sep. 11, 2019 (JP) 2019-165760

(51) Int. Cl. B01D 46/24; F01N 3/28; F01N 3/20; F01N 3/027; F01N 3/035; B01D 46/00; B01D 46/42; B01D 46/84; B01D 53/94; C04B 38/00; B01J 35/04; H05B 6/10

(52) U.S. Cl. CPC B01D 46/2478; H05B 6/36; F01N 3/2013; F01N 3/027; F01N 3/035; B01D 46/0027; B01D 46/2466; B01D 46/2448; B01D 46/24494; B01D 46/4263; B01D 46/84; B01D 53/94; B01D 46/2482; C04B 38/0016; B01J 35/04; H05B 6/108; F01N 2330/06; F01N 2330/34; F01N 2350/02; F01N 2370/02; F01N 2510/06; B01D 2279/30; F01N 3/2828

(57) ABSTRACT

A pillar shaped honeycomb structure including pillar shaped honeycomb segments joined together via joining material layers, wherein each of the pillar shaped honeycomb segment includes: an outer peripheral wall; and a porous partition wall disposed on an inner side of the outer peripheral wall, the partition wall defining a plurality of cells, each of the cells extending from one end face to other end face to form a flow path, and wherein a metal member is embedded in each of the joining material layer.

### FIELD OF THE INVENTION

The present invention relates to a honeycomb structure and an exhaust gas purifying device.

### BACKGROUND OF THE INVENTION

Exhaust gases from motor vehicles typically contain harmful components such as carbon monoxide, hydrocarbons and nitrogen oxides and/or fine particles of carbon or the like as a result of incomplete combustion. From the viewpoint of reducing health hazards to a human body, there is an increasing need for reducing harmful gas components and fine particles in exhaust gases from motor vehicles.

However, at present, these harmful components are discharged during a period immediately after an engine is started, i.e., a period during which a catalyst temperature is lower and a catalytic activity is insufficient. Therefore, the harmful components in the exhaust gas may be discharged without being purified by the catalyst before reaching the catalyst activation temperature. In order to satisfy such a need, it is necessary to reduce emission as much as possible, which is discharged without being purified by a catalyst before reaching a catalytic activity temperature. For example, measures using an induction heating technique are known in the art.

As such an art, Patent Literature 1 proposes a technique for inserting a magnetic wire into a part of cells of a cordierite honeycomb widely used as a catalyst supported honeycomb. According to this technique, a current can be passed through the coil on an outer circumference of the honeycomb to increase a wire temperature by induction heating, and its heat can increase a temperature of the honeycomb.

### CITATION LIST

### Patent Literature

[Patent Literature 1] U.S. Patent Application Publication No. 2017/0022868 A1

### SUMMARY OF THE INVENTION

However, as disclosed in Patent Literature 1, the inserting of the magnetic wires into some of the cells of the honeycomb structure causes a problem that the cells having the inserted magnetic wires sacrifice the flow path for allowing the exhaust gas to flow, resulting in an increased pressure loss.

In view of the above circumstances, an object of the present invention is to provide a honeycomb structure and an exhaust gas purifying device, which can have good suppression of pressure loss, and can burn out and remove carbon fine particles by induction heating or heat a catalyst to be supported on the honeycomb structure.

As a result of intensive studies, the present inventors have found that the above problems can be solved by configuring a pillar shaped honeycomb structure comprising pillar shaped honeycomb segments joined together via joining material layers such that a metal member is embedded in each of the joining material layers. That is, the present invention is specified as follows:

(1) A pillar shaped honeycomb structure comprising pillar shaped honeycomb segments joined together via joining material layers,

wherein each of the pillar shaped honeycomb segment comprises: an outer peripheral wall; and porous partition walls disposed on an inner side of the outer peripheral wall, the partition walls defining a plurality of cells, each of the cells extending from one end face to other end face to form a flow path, and

wherein a metal member is embedded in the joining material layer.

(2) A pillar shaped honeycomb structure, comprising: an outer peripheral wall; and porous partition walls disposed on an inner side of the outer peripheral wall, the partition walls defining a plurality of cells, each of the cells extending from one end face to other end face to form a flow path,

wherein a metal member is arranged inside the outer peripheral wall or on a surface of the outer peripheral wall.

(3) An exhaust gas purifying device, comprising:

the honeycomb structure according to (1) or (2);

a coil wiring that spirally surrounds an outer periphery of the honeycomb structure; and

a metal pipe for housing the honeycomb structure and the coil wiring.

According to the present invention, it is possible to provide a honeycomb structure and an exhaust gas purifying device, which can have good suppression of pressure loss, and can burn out and remove carbon fine particles by induction heating or heat a catalyst to be supported on the honeycomb structure.

### BRIEF DESCRIPTION OF THE DRAWINGS

FIG. 1 is a schematic external view of a pillar shaped honeycomb structure according to an embodiment of the present invention;

FIG. 2 is a schematic cross-sectional view perpendicular to an axial direction of a honeycomb structure according to an embodiment of the present invention;

FIG. 3 is a cross-sectional view schematically showing a cross section parallel to an axial direction of cells having plugged portions and partition walls of a honeycomb segment according to an embodiment of the present invention;

FIG. 4 is a schematic cross-sectional view parallel to an axial direction of a honeycomb structure according to an embodiment of the present invention;

FIG. 5 is a schematic cross-sectional view perpendicular to an axial direction of a honeycomb structure according to another embodiment of the present invention;

FIG. 6 (A) is a schematic cross-sectional view parallel to an axial direction of a honeycomb structure according to another embodiment of the present invention;

FIG. 6 (B) is a schematic cross-sectional view parallel to an axial direction of a honeycomb structure according to still another embodiment of the present invention;

FIG. 7 (A) is a schematic external view of a pillar shaped honeycomb structure according to another embodiment of the present invention;

FIG. 7 (B) is a schematic cross-sectional view perpendicular to an axial direction of a honeycomb structure according to still another embodiment of the present invention;

FIG. 7 (C) is a schematic cross-sectional view perpendicular to an axial direction of a honeycomb structure according to still another embodiment of the present invention;

FIG. 8 is a schematic external view of a pillar shaped honeycomb structure according to still another embodiment of the present invention;

FIG. 9 is a schematic cross-sectional view perpendicular to an axial direction of a honeycomb structure according to still another embodiment of the present invention;

FIG. 10 is a schematic cross-sectional view parallel to an axial direction of a honeycomb structure according to still another embodiment of the present invention;

FIG. 11 (A) is a schematic cross-sectional view parallel to an axial direction of a honeycomb structure according to still another embodiment of the present invention;

FIG. 11 (B) is a schematic cross-sectional view parallel to an axial direction of a honeycomb structure according to still another embodiment of the present invention;

FIG. 12 is a schematic view of an exhaust gas flow path of an exhaust gas purifying device incorporating a honeycomb structure; and

FIG. 13 is a graph showing results of a heating test for a honeycomb structure according to Example.

### DETAILED DESCRIPTION OF THE INVENTION

Hereinafter, embodiments of a honeycomb structure according to the present invention will be described with reference to the drawing. However, the present invention is not limited to these embodiments, and various changes, modifications, and improvements may be made based on knowledge of those skilled in the art, without departing from the scope of the present invention.

### <1. Honeycomb Structure>

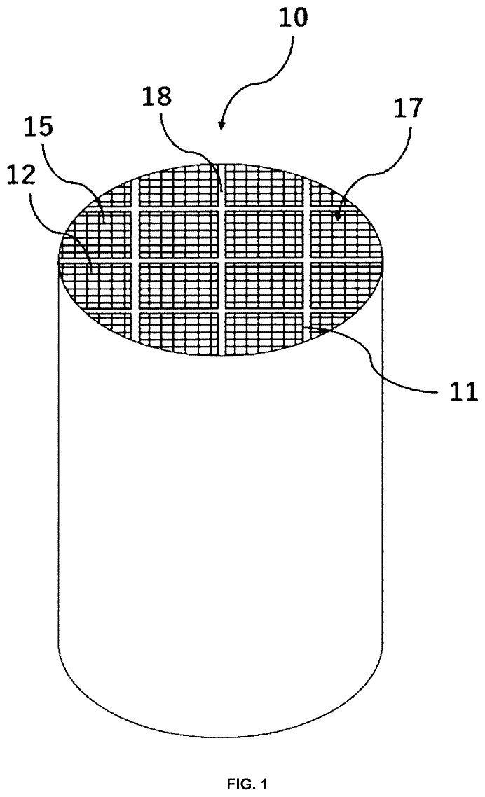

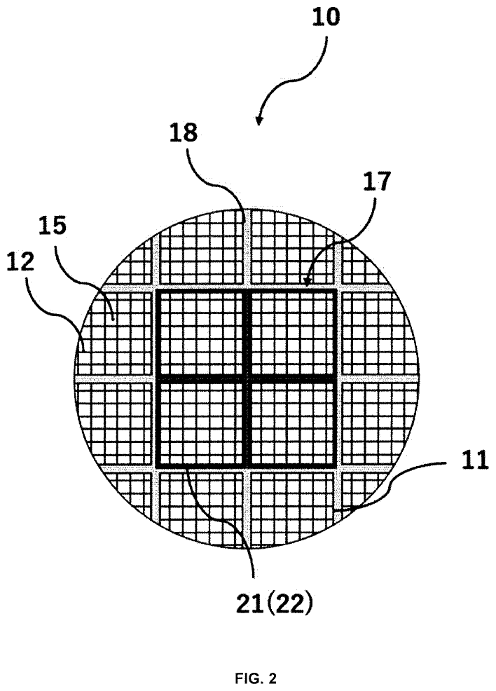

FIG. 1 shows a schematic external view of a pillar shaped honeycomb structure 10 according to an embodiment of the present invention. FIG. 2 shows a schematic cross-sectional view of the honeycomb structure 10 perpendicular to the axial direction. The honeycomb structure 10 is structured by joining a plurality of pillar shaped honeycomb segments 17 via joining material layers 18. Each of the honeycomb segments 17 has an outer peripheral wall 11 and porous partition walls 12 which are arranged on an inner side of the outer peripheral wall 11 and define a plurality of cells 15 that extend from one end face to the other end face to form flow paths.

Further, an outer shape of the honeycomb structure 10 may be, but not particularly limited to, a shape such as a pillar shape with circular end faces (cylindrical shape), a pillar shape with oval end faces, and a pillar shape with polygonal (square, pentagonal, hexagonal, heptagonal, octagonal, and the like) end faces, and the like. Furthermore, the size of the honeycomb structure 10 is not particularly limited, and an axial length of the honeycomb structure is preferably from 40 to 500 mm. Further, for example, when the outer shape of the honeycomb structure 10 is cylindrical, a radius of each end face is preferably from 50 to 500 mm.

The outer shape of the honeycomb structure 10 may be the same as or different from that of each of the honeycomb segments 17. For example, a plurality of pillar shaped honeycomb segments 17 having quadrangular end faces may be joined via joining material layers 18 to form a honeycomb structure 10 having quadrangular end faces as well. Also, a plurality of pillar shaped honeycomb segments 17 having quadrangular end faces may be joined via the joining material layers 18 to form a joined body having quadrangular end faces as a whole, and an outer periphery of the joined body may be ground to form the pillar shaped honeycomb structure 10 having circular end faces.

Although materials of the partition walls 12 and the outer peripheral wall 11 of each honeycomb segment 17 are not particularly limited, the honeycomb segment is required to be a porous body having a large number of pores. Therefore, the honeycomb segment 1 is typically formed of a ceramic material. Examples of the ceramic material include a sintered body of ceramics comprised of cordierite, silicon carbide, silicon, aluminum titanate, silicon nitride, mullite, alumina, a silicon-silicon carbide-based composite material, or silicon carbide-cordierite based composite material, in particular, a sintered body mainly based on a silicon-silicon carbide composite material or silicon carbide. As used herein, the expression “silicon carbide-based” means that the honeycomb segment 17 contains silicon carbide in an amount of 50% by mass or more of the entire honeycomb segment 17. The phrase “the honeycomb segment 17 is mainly based on a silicon-silicon carbide composite material” means that the honeycomb segment 17 contains 90% by mass or more of the silicon-silicon carbide composite material (total mass) based on the entire honeycomb structure 10. Here, for the silicon-silicon carbide composite material, it contains silicon carbide particles as an aggregate and silicon as a binding material for binding the silicon carbide particles, and a plurality of silicon carbide particles are preferably bonded by silicon so as to form pores between the silicon carbide particles. The phrase “the honeycomb segment 17 is mainly based on silicon carbide” means that the honeycomb segment 17 contains 90% by mass or more of silicon carbide (total mass) based on the entire honeycomb segment 17.

The honeycomb segment 17 preferably has a higher thermal conductivity, in terms of heating the honeycomb segment 17 to the interior of the segment in a short period of time. The material for this purpose preferably includes at least one ceramic material selected from the group consisting of silicon carbide, silicon, and silicon nitride. The thermal conductivity of the ceramic material of the honeycomb segment 17 is preferably 3 W/mK or more, and more preferably 10 W/mK or more.

The honeycomb segment 17 preferably has a value of a thermal expansion coefficient of the ceramic material that is closer to that of the metal member, in terms of suppressing thermal stress generated by a difference between the thermal expansion coefficients of the ceramic material and the metal member during heating. Preferably, the material for this purpose includes ceramic materials such as at least one ceramic material selected from the group consisting of silicon carbide, silicon, and silicon nitride; mullite; alumina, and the like. The thermal expansion coefficient of the ceramic material of the honeycomb segment 17 is preferably 3×10⁻⁶ or more. The thermal expansion coefficient is measured with a thermal expansion meter, for example, in a range of room temperature to 800° C.

A shape of each cell of the honeycomb segment 17 may be, but not particularly limited to, preferably a polygonal shape such as a triangle, a quadrangle, a pentagon, a hexagon and an octagon; a circular shape; or an ellipse shape, or undefined shape, in a cross section orthogonal to the central axis of the honeycomb segment 17.

Each of the partition walls 12 of the honeycomb segment 17 preferably have a thickness of from 0.10 to 0.50 mm, and more preferably from 0.25 to 0.45 mm, in terms of ease of production. For example, the thickness of 0.10 mm or more improves the strength of the honeycomb structure 10. The thickness of 0.50 mm or less can result in lower pressure loss when the honeycomb structure 10 is used as a filter. It should be noted that the thickness of the partition walls 12 is an average value measured by a method for observing the axial cross section with a microscope.

Further, the partition walls 12 forming the honeycomb segment 17 preferably have a porosity of from 30 to 70%, and more preferably from 40 to 65%, in terms of ease of production. The porosity of 30% or more of the partition walls 12 tends to decrease a pressure loss. The porosity of 70% or less can maintain the strength of the honeycomb structure 10.

The porous partition walls 12 preferably have an average pore size of from 5 to 30 μm, and more preferably from 10 to 25 μm. The average pore size of 5 μm or more can decrease the pressure loss when the honeycomb structure 10 is used as a filter. The average pore size of 30 μm or less can maintain the strength of the honeycomb structure 10. As used herein, the terms “average pore diameter” and “porosity” mean an average pore diameter and a porosity measured by mercury porosimetry, respectively.

The honeycomb segment 17 preferably has a cell density in a range of from 5 to 93 cells/cm², and more preferably 5 to 63 cells/cm², and even more preferably in a range of from 31 to 54 cells/cm². The cell density of the honeycomb segment 17 of 5 cells/cm² or more can allow the pressure loss to be easily reduced, and the cell density of 93 cells/cm² or less can allow the strength of the honeycomb structure 10 to be maintained.

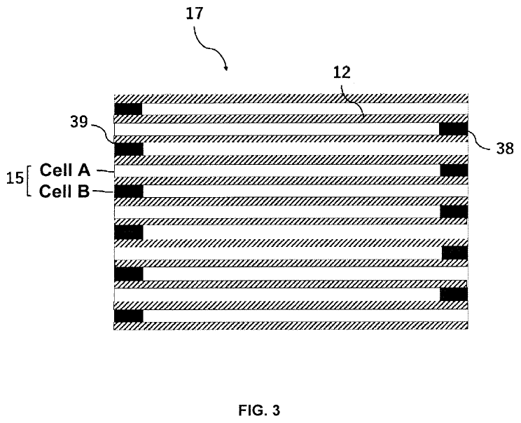

As illustrated in FIG. 3, the honeycomb segment 17 may include: a plurality of cells A which are opened on the one end face side and have plugged portions 38 on the other end face; and a plurality of cells B which are arranged alternately with the cells A, and which are opened on the other end face side and have plugged portions 39 on the one end face. The cells A and the cells B are alternately arranged so as to be adjacent to each other across the partition walls 12, and both end faces form a checkered pattern. The numbers, arrangements, shapes and the like of the cells A and B, are not limited, and they may be appropriately designed as needed. Such a honeycomb structure 10 can be used as a filter (honeycomb filter) for purifying an exhaust gas. It should be noted that when the honeycomb structure 10 is not used as the honeycomb filter, the plugged portions 38, 39 may not be provided.

The honeycomb structure 10 according to the present embodiment may have a catalyst supported on the surfaces of the partition walls 12 and/or in pores of the partition walls 12.

A type of the catalyst is not particularly limited, and it can be appropriately selected according to the use purposes and applications of the honeycomb structure 10. Examples of the catalyst include noble metal catalysts or other catalysts. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a NOₓ storage reduction catalyst (LNT catalyst) containing an alkaline earth metal and platinum as storage components for nitrogen oxides (NOₓ). Illustrative examples of a catalyst that does not use the noble metal include a NOₓ selective reduction catalyst (SCR catalyst) containing a copper-substituted or iron-substituted zeolite, and the like. Also, two or more catalysts selected from the group consisting of those catalysts may be used. A method for supporting the catalyst is not particularly limited, and it can be carried out according to a conventional method for supporting the catalyst on the honeycomb structure.

The honeycomb structure 10 may have surface layers having permeability on at least a part of the surfaces of the partition walls 12. As used herein, the the expression “having permeability” means that a permeability of each surface layer is 1.0×10⁻¹³ m² or more. From the viewpoint of further reducing the pressure loss, the permeability is preferably 1.0×10⁻¹² m² or more. Since each surface layer has the permeability, the pressure loss of the honeycomb structure 10 caused by the surface layers can be suppressed.

Further, as used herein, the “permeability” refers to a physical property value calculated by the following equation (1), which value is an index indicating passing resistance when a certain gas passes through an object (partition walls 12). Here, in the following equation (1), C represents a permeability (m²), F represents a gas flow rate (cm³/s), T represents a thickness of a sample (cm), V represents a gas viscosity (dynes·sec/cm²), D represents a diameter of a sample (cm), P represents a gas pressure (PSI). The numerical values in the following equation (1) are: 13.839 (PSI)=1 (atm) and 68947.6 (dynes·sec/cm²)=1 (PSI).

$$\begin{matrix}[ Equation 1 ] & \\ C = \frac{8 FTV}{{π D}^{2} ( {P}^{2} - {13.839}^{2} ) / 13.839 \times 68947.6} \times {10}^{- 4} & ( 1 )\end{matrix}$$

When measuring the permeability, the partition walls 12 with the surface layers are cut out, the permeability is measured on the partition walls 12 with the surface layers, and the permeability is then measured on the partition walls 12 from which the surface layers have been removed. From a ratio of thicknesses of the surface layer and the partition wall and the permeability measurement results, the permeability of the surface layers is calculated.

The surface layers preferably have a porosity of 50% or more, and more preferably 60% or more, and still more preferably 70% or more. By having the porosity of 50% or more, the pressure loss can be suppressed. However, if the porosity is too high, the surface layers become brittle and easily peels off. Therefore, the porosity is preferably 90% or less.

As a method of measuring the porosity of the surface layers by the mercury press-in method, a difference between a mercury porosity curve of a sample having surface layers and a substrate and a mercury porosity curve of only the substrate from which only the surface layers have been scrapped off and removed is determined to be a mercury porosity curve of the surface layers, and the porosity of the surface layers is calculated from the mass of the scraped surface layers and the mercury porosity curve. A SEM image may be taken, and the porosity of the surface layers may be calculated from an area ratio of the void portions and the substantive portions by image analysis of the surface layer portions.

The surface layers preferably have an average pore diameter of 10 μm or less, and more preferably 5 μm or less, and further preferably 4 μm or less, and particularly preferably 3 μm or less. The average pore diameter of 10 μm or less can achieve a higher particle collection efficiency. However, if the average pore diameter of the surface layers is too low, the pressure loss will increase. Therefore, the average pore diameter is preferably 0.5 μm or more.

As a method of measuring the average pore diameter of the surface layers by the mercury press-in method, in the form of peak values in the mercury porosimeter, a difference between a mercury porosity curve (pore volume frequency) on the substrate on which the surface layers are formed and a mercury porosity curve on only the substrate from which only the surface layers have been scrapped off and removed is determined to be a mercury porosity curve of the surface layers, and its peak is determined to be the average pore diameter. Further, an SEM image of the cross section of the honeycomb structure 10 may be taken, and the surface layer portion may be subject to image analysis to binarize the void portions and the substantive portions, and twenty or more voids may be randomly selected to average the inscribed circles, and the average may be determined to be the average pore diameter.

Further, the thickness of each surface layer is not particularly limited. However, in order to obtain the effect of the surface layers more remarkably, the thickness of each surface layer is preferably 10 μm or more. On the other hand, from the viewpoint of avoiding an increase in pressure loss, the thickness of each surface layer is preferably 80 μm or less. The thickness of each surface layer is more preferably 50 μm or less. For a method of measuring the thickness of each surface layer, for example, the honeycomb structure 10 on which the surface layers are formed is cut in a direction perpendicular to the cell extending direction, and the thickness of each surface layer is measured from the cross section of the honeycomb structure 10, and the measured thicknesses at arbitrary five points can be averaged.

A joining material forming the joining material layers 18 for joining the honeycomb segments 17 that can be used herein may be prepared by, for example, mixing ceramic powder, ceramic fibers, a dispersion medium (for example, water or the like), and optionally additives such as an inorganic binder, an organic binder, a deflocculant and a foaming resin. The ceramics may be preferably ceramics containing at least one selected from the group consisting of cordierite, mullite, zircon, aluminum titanate, silicon carbide, silicon nitride, zirconia, spinel, indialite, sapphirine, corundum, and titania, and more preferably having the same material as that of the honeycomb segment 17. The addition of the ceramic fibers is effective for imparting a function of stress relaxation, and alumina fibers, magnesium silicate fibers, and the like are suitably used in terms of compliance with REACH regulations. The inorganic binder includes colloidal silica, and the organic binder includes polyvinyl alcohol, methyl cellulose, CMC (carboxymethyl cellulose) and the like.

The metal member 21 is embedded in the joining material layers 18 on the honeycomb structure 10. Such a structure can allow an electric current to be applied to a coil wiring around the outer periphery of the honeycomb structure 10, and the temperature of the metal member 21 to be increased by induction heating, which heat can allow the temperature of the honeycomb structure 10 to be increased. The honeycomb structure 10 has no effect on the pressure loss because the metal members 21 are embedded in the joining material layers 18, rather than in the cells 15.

A preferable shape of the metal member 21 include, but not limited to, a wire, foil, or mesh shape. The metal member 21 in the wire, foil, or mesh shape can result in easy embedding of the metal member 21 in the joining material layer 18 and efficient arrangement around the honeycomb segment 17.

When the metal member 21 is formed into the wire shape and used as a metal wire, the metal wire is preferably provided so as to go around the outer periphery of the honeycomb segment 17 within the joining material layer 18. Such a configuration can allow the metal member 21 to be arranged around the honeycomb segment 17 more efficiently. The metal wire is preferably provided on the surface of the honeycomb segment 17 in the joining material layer 18. Such a configuration can allow the honeycomb segments 17 to be effectively heated.

When the metal member 21 is formed into the foil shape and used as a metal foil, the metal foil is preferably provided on the surface of the honeycomb segment 17 in the joining material layer 18. Also, the metal foil is more preferably provided so as to cover the entire surface of the honeycomb segment 17 in the joining material layer 18. Such a configuration can allow the honeycomb segments 17 to be effectively heated.

When the metal member 21 is formed into the mesh shape and used as a metal mesh, the metal mesh is preferably provided on the surface of the honeycomb segment 17 in the joining material layer 18. Also, the metal mesh is more preferably provided so as to cover the entire surface of the honeycomb segment 17 in the joining material layer 18. Such a configuration can allow the honeycomb segments 17 to be effectively heated.

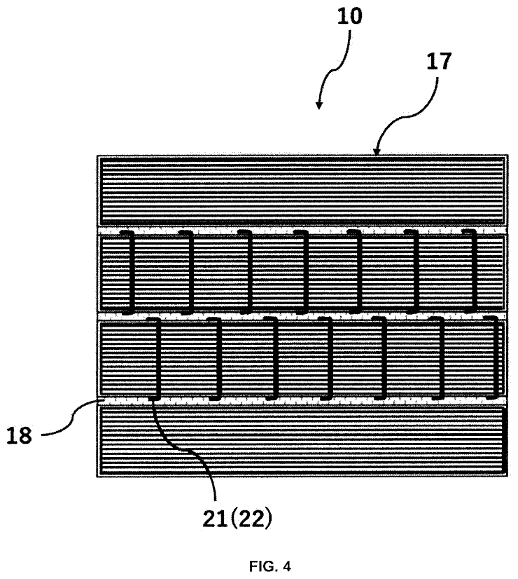

FIG. 2 shows an example of the metal member 21 formed into the wire shape and used as a metal wire 22. FIG. 4 shows a schematic cross-sectional view parallel to the axial direction of the honeycomb structure 10 shown in FIG. 2. The metal wire 22 is provided to go around the outer periphery of the honeycomb segment 17, and forms a flow path for loop current, which circumferentially cover the outer periphery of the honeycomb segment 17 in a cross section perpendicular to the axial direction of the honeycomb structure 10. Such a structure can allow the current to flow so as to circulate around the metal wire 22 to generate the loop current easily. This can allow for induction heating even at a relatively low frequency of several tens of kHz or less. Further, since the loop current is easily generated by the arrangement of the metal wire 22, there is no restriction on a Curie point of the material, such as a need to necessarily use a ferromagnetic substance for the metal wire 22, whereby the honeycomb structure 10 having a good heating rate can be obtained. The size of the metal wire 22 is not particularly limited, but for example, the metal wire 22 can be formed to have a diameter of from 0.3 to 2 mm.

In each of the honeycomb structures 10 shown in FIGS. 2 and 4, one honeycomb segment 17 is provided with a plurality of metal wires 22. The respective metal wires 22 are each formed in a ring shape so as to go around the honeycomb segment 17, and are spaced apart from each other. According to such a structure, even if some of the metal wires 22 are subjected to damage such as cutting, the other metal wires 22 remaining as ring-shaped metal members 21 that go around the honeycomb segments 17 can prevent the entire honeycomb segment 17 from being not heated. Each metal wire 22 may be wrapped around the honeycomb segment 17 within the joining material layer 18, or may be spaced apart from the surface of the honeycomb segment 17.

The number of the honeycomb segments 17 provided with the metal wires 22 that go around the honeycomb segments 17 is not particularly limited, and it can be adjusted as needed depending on desired induction heating efficiencies. In the honeycomb structure 10 of FIG. 2, four honeycomb segments 17 in each of the vertical and horizontal directions, 16 honeycomb segments 17 in total, are joined by the joining material layers 18, of which 12 honeycomb segments 17 located at the outer periphery are ground during the production step and do not retain their original shapes. Except for the 12 honeycomb segments 17, the 4 central honeycomb segments 17 are surrounded by the metal wires 22, respectively. It is thus preferable to provide the metal wires 22 around all of the honeycomb segments 17 other than those located at the outer periphery of the honeycomb structure 10, as this will further increase the induction heating efficiency.

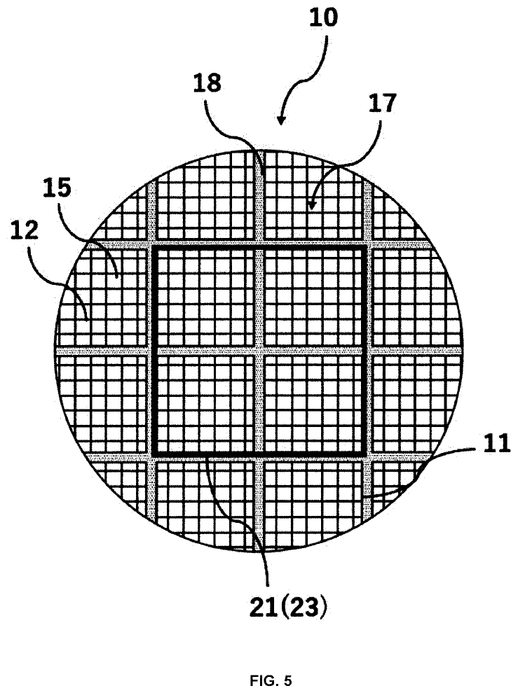

In each of the honeycomb structures 10 shown in FIGS. 2 and 4, the metal wires 22 are provided to go around one honeycomb segment 17 along its outer periphery, although not limited thereto. As shown in FIG. 5, the metal wires 22 may be provided so as to go around the outer periphery of one segment comprised of the 4 honeycomb segments 17 in total, i.e., two honeycomb segments 17 adjacent to each other in each of the vertical and horizontal directions. Such a structure can allow a larger loop current to be generated, thereby enabling induction heating even at a lower frequency. In FIG. 5, the four honeycomb segments 17 are provided as a single segment so that the metal wires 23 go around the periphery of the segment, although not limited thereto as long as they serve as flow paths for the loop current. For example, two, three, five or more honeycomb segments 17 may be grouped together as a single segment and the metal wires 23 may be provided so as to go around the outer periphery of the single segment.

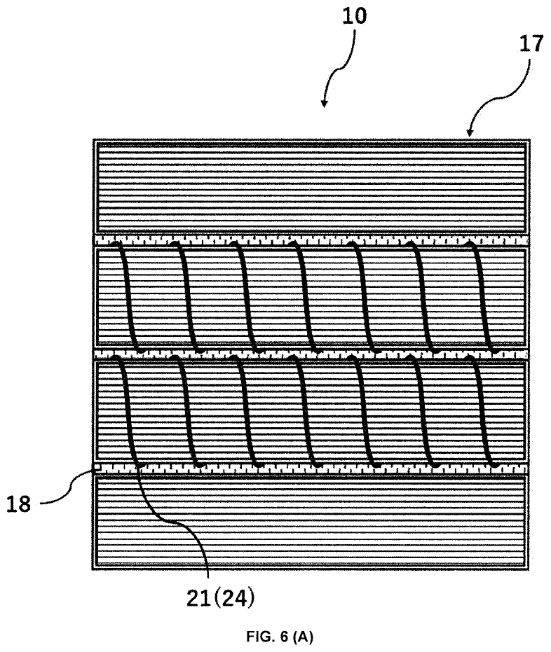

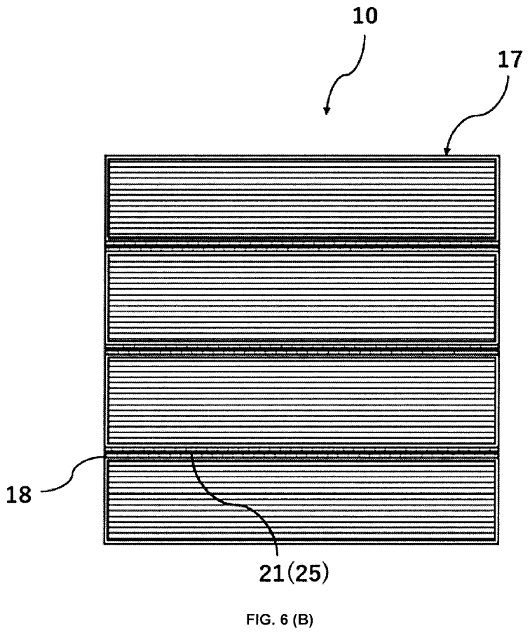

In each of the honeycomb structures 10 shown in FIGS. 2 and 4, one honeycomb segment 17 is provided with a plurality of metal wires 22 in the ring shapes that go around the one honeycombs segment 17, and are spaced apart from each other. However, as shown in FIG. 6 (A), one honeycomb segment 17 may be provided with one metal wire 24 so as to spirally go around the honeycomb segment 17. Since one metal wire 24 thus spirally goes around the honeycomb segment 17, only one metal wire 24 can go around the honeycomb segment 17 anywhere along the axial direction. Such a structure can allow the metal member 21 to be efficiently embedded in the joining material layer 18. The metal wire 24 may be wrapped around the honeycomb segment 17 within the joining material layer 18, or may be spaced apart from the surface of the honeycomb segment 17.

As shown in FIG. 6 (B), the honeycomb structure 10 may be provided with a metal wires 25 extending parallel to the axial direction of the honeycomb segment 17 in the joining material layer 18. Although one metal wire 25 may be provided in the joining material layer 18 between two honeycomb segments 17 that are adjacent to each other, it is preferable to have two or more metal wires, because the heating efficiency of the honeycomb segments 17 is improved.

The metal members 21 may be provided in the entire honeycomb segment 17 or in some regions the honeycomb segment 17 in the axial direction. When the metal members 21 are provided in the entire honeycomb segment 17 in the axial direction, the heating efficiency of the honeycomb segment 17 will be more improved. When the metal member 21 is provided in a part of the honeycomb segment 17 in the axial direction, for example, when the metal member 21 is provided in a region on an inlet side of the gas flow path of the honeycomb segment 17, the entire honeycomb segment 17 can be efficiently heated, because the gas heated at a starting position of the gas flow proceeds to an outlet side of the honeycomb segment 17. Further, since soot tends to be accumulated at the outlet side of the gas flow path of the honeycomb segment 17, the soot accumulated in the honeycomb segment 17 can be more effectively removed when the metal member 21 is provided in the region on the outlet side. Furthermore, when the metal member 21 is provided in a part of the honeycomb segment 17 in the axial direction, a coil provided on the outer periphery of the honeycomb structure 10 can be made compact when the honeycomb structure 10 is used as an exhaust gas purifying device.

The metal member 21 can be made of one or more selected from the group consisting of copper, iron, aluminum, nickel, chromium, and cobalt. Such a configuration provides a heating effect due to eddy current loss caused by the flow of electric current in a conductor. The use of the metal wire as the metal member provides an advantage that good heating is possible even if the frequency is lower such as several tens of kHz, because the length of the path through which eddy currents flow can be ensured.

It is preferable that the metal member 21 is at least partially made of a magnetic substance. Such a configuration provides an improved heating efficiency of the honeycomb segments 17 due to an effect of increasing magnetic field density, permeability, which have an effect on eddy current loss. The content ratio of the magnetic substance in the metal member 21 can be designed as needed in view of the heating efficiency of the honeycomb structure 10. The magnetic substance making up the metal member 21 is preferably contained in an amount of 20% or more by volume of the metal member 21, and the entire metal member 21 is preferably made of the magnetic substance. The metal members 21 which are made of the magnetic substance and those which are made of a metal material other than the magnetic substance may be separately provided in the joining material layer 18.

The magnetic substance of the metal member 21 preferably has a Curie point of 450° C. or more. The Curie point of the magnetic substance of 450° C. or more can enable a catalyst supported on the honeycomb temperature 10 to be heated, as well as this can lead to an ease to burn out and remove PMs (particulate matters) collected in the cells 15 to regenerate a honeycomb structure filter. The magnetic substance having a curry point of 450° C. or more includes, for example, the balance Co-20% by mass of Fe; the balance Co-25% by mass of Ni-4% by mass of Fe; the balance Fe-15-35% by mass of Co; the balance Fe-17% by mass of Co-2% by mass of Cr-1% by mass of Mo; the balance Fe-49% by mass of Co-2% by mass of V; the balance Fe-18% by mass of Co-10% by mass of Cr-2% by mass of Mo-1% by mass of Al; the balance Fe-27% by mass of Co-1% by mass of Nb; the balance Fe-20% by mass of Co-1% by mass of Cr-2% by mass of V; the balance Fe-35% by mass of Co-1% by mass of Cr; pure cobalt; pure iron; electromagnetic soft iron; the balance Fe-0.1-0.5% by mass of Mn; the balance Fe-3% by mass of Si; the balance Fe-6.5% by mass of Si; the balance Fe-18% by mass of Cr; the balance Ni-13% by mass of Fe-5.3% by mass of Mo; the balance Fe-45% by mass of Ni; and the like. Here, the Curie point of the magnetic substance refers to a temperature at which a ferromagnetic property is lost.

The magnetic substance of the metal member 21 preferably has an intrinsic resistance value of 20 μΩcm or more at 25° C. According to such a configuration, an amount of heat generated by induction heating can be further increased. Examples of the magnetic substance having an intrinsic resistance value of 20 μΩcm or more at 25° C. include the balance Fe-18% by mass of Cr; the balance Fe-13% by mass of Cr-2% by mass of Si; the balance Fe-20% by mass of Cr-2% by mass of Si-2% by mass of Mo; the balance Fe-10% by mass of Si-5% by mass of Al; the balance Fe-18% by mass of Co-10% by mass of Cr-2% by mass of Mo-1% by mass of Al; the balance Fe-36% by mass of Ni; the balance Fe-45 by mass of Ni; the balance Fe-49% by mass of Co-2% by mass of V; the balance Fe-18% by mass of Co-10% by mass of Cr-2% by mass of Mo-1% by mass of Al; the balance Fe-17% by mass of Co-2% by mass of Cr-1% by mass of Mo; and the like.

The magnetic substance of the metal member 21 preferably has a maximum magnetic permeability of 1000 or more. According to such a configuration, when the honeycomb structure 10 is dielectrically heated, the temperature can be raised in a short period of time until a temperature at which water vaporizes (about 100° C.), and further until a temperature at which the catalyst is activated (about 300° C.). Examples of the magnetic substance having a maximum magnetic permeability of 1000 or more include the balance Fe-10% by mass of Si-5% by mass of Al; 49% by mass of Co-49% by mass of Fe-2% by mass of V; the balance Fe-36% by mass of Ni; the balance Fe-45% by mass of Ni; the balance Fe-35% by mass of Cr; the balance Fe-18% by mass of Cr; and the like.

The magnetic substance of the metal member 21 is magnetized by a magnetic field, and a state of magnetization varies depending on the intensity of the magnetic field. This is represented by a “magnetization curve”. The magnetization curve may have a magnetic field H on a horizontal axis and a magnetic flux density B on a vertical axis (B-H curve). A state where no magnetic field is applied to the magnetic substance refers to a degaussing state, which is represented by an origin O. As a magnetic field is applied, a curve in which the magnetic flux density increases from the origin O to a saturated state is drawn. This curve is an “initial magnetization curve”. A slope of a straight line connecting a point on the initial magnetization curve to the origin is a “permeability”. The permeability indicates an ease of magnetization of the magnetic substance in such a sense that the magnetic field permeates. The magnetic permeability near the origin where the magnetic field is smaller is an “initial magnetic permeability”, and a magnetic permeability that is maximum on the initial magnetization curve is a “maximum magnetic permeability”.

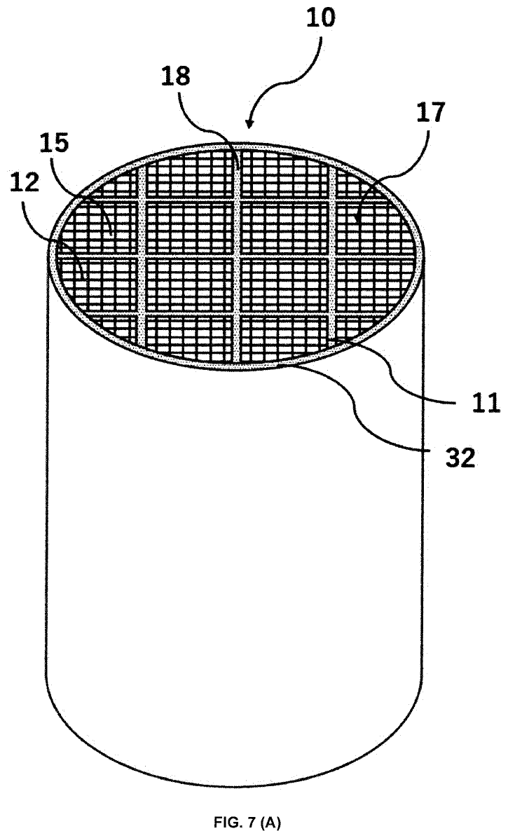

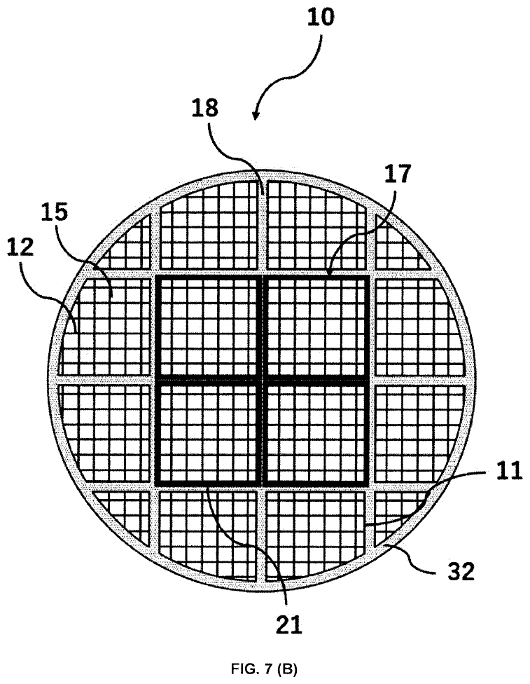

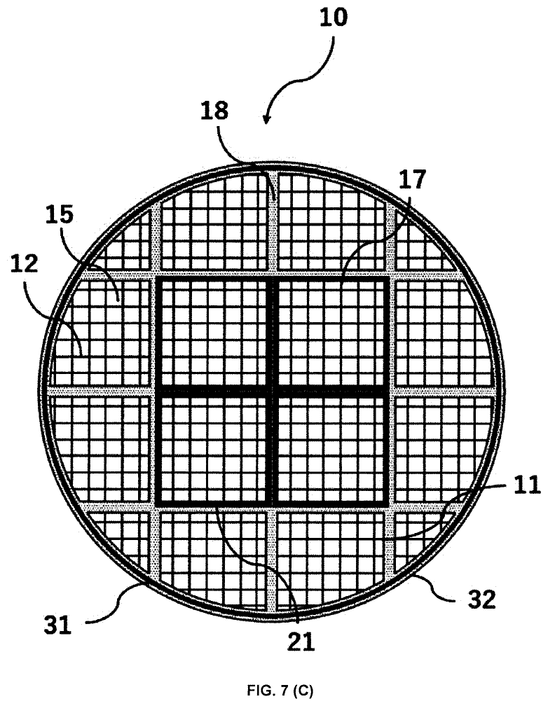

The honeycomb structure 10 may have a coating layer 32 on the outer peripheral surface, as shown in FIGS. 7 (A) and 7 (B). A material making up the coating layer 32 is not particularly limited, and various known coating materials can be appropriately used. The coating material may further contain colloidal silica, an organic binder, clay and the like. The organic binder is preferably used in an amount of from 0.05 to 0.5% by mass, and more preferably from 0.1 to 0.2% by mass. Further, the clay is preferably used in an amount of from 0.2 to 2.0% by mass, and more preferably from 0.4 to 0.8% by mass.

As shown in FIG. 7 (C), a metal member 31 may be further arranged inside the coating layer 32. Such a structure can allow the honeycomb structure 10 to be more effectively heated. The metal member 31 may be disposed on the surface of the coating layer 32. The metal member 31 may be provided so as to go around the outermost periphery of the honeycomb structure 10, or may be provided so as to extend parallel to the axial direction of the honeycomb structure 10.

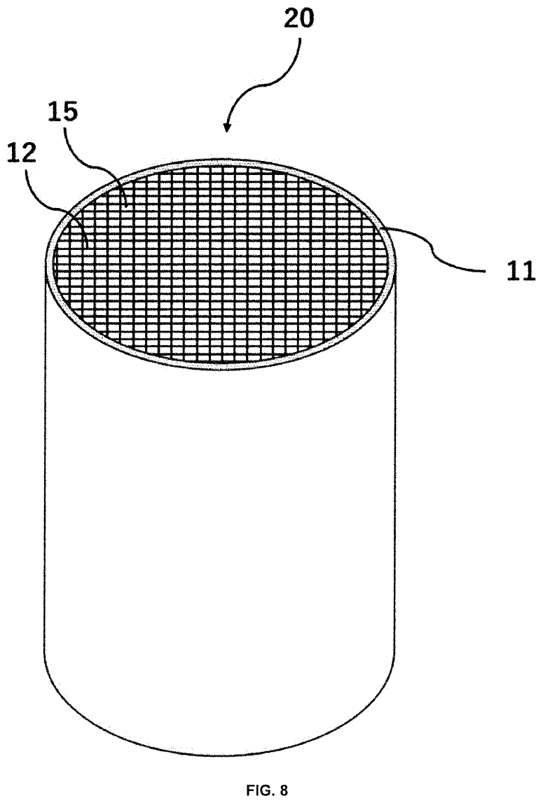

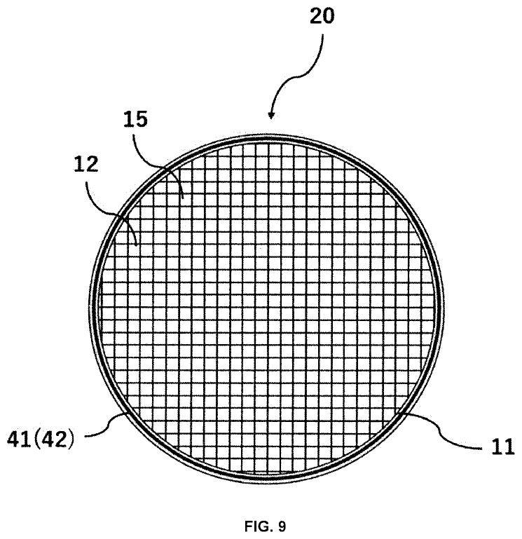

FIG. 8 shows an external schematic view of a pillar shaped honeycomb structure 20 according to another embodiment of the present invention. FIG. 9 shows a schematic cross-sectional view of the honeycomb structure 20 perpendicular to the axial direction. The honeycomb structure 20 has an outer peripheral wall 11 and porous partition walls 12 that are arranged on an inner side of the outer peripheral wall 11 and define a plurality of cells 15 each extending from one end face to the other to form a flow path. The interior of the outer peripheral wall 11 is provided with a metal member 41. The metal member may be disposed on the surface of the outer peripheral wall 11. Such a structure can allow an electric current to be applied to a coil around the outer periphery of the honeycomb structure 20 to increase a temperature of the metal member 41 by induction heating, which heat can allow the honeycomb temperature to be increased. Further, the honeycomb structure 20 can well suppress the pressure loss, because the metal member 41 is arranged on the inner side of the outer peripheral wall 11, rather than in the cells 15.

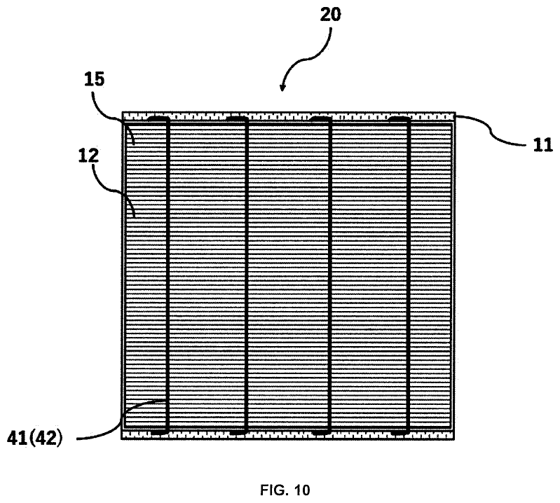

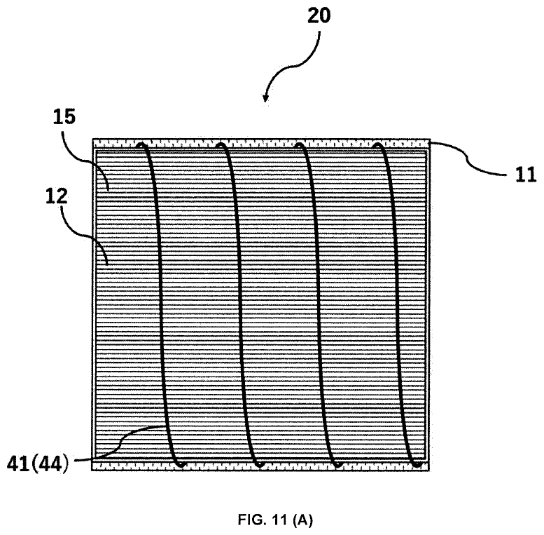

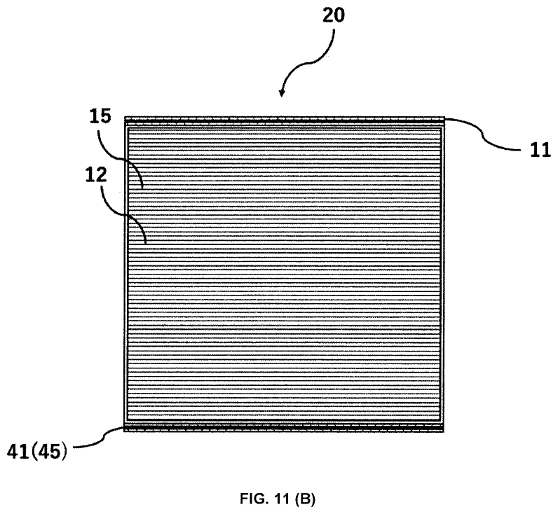

The metal member 41 of the honeycomb structure 20 can use the same form and material as those of the metal member 21 of the honeycomb structure 10 described above. For example, as shown in FIGS. 9 and 10, the metal member 41 may be formed into a wire shape and used as a metal wire 42. The metal wire 42 is provided to go around the outer periphery of the honeycomb structure 20, and forms a loop current flow path that circulates along the outer periphery of the honeycomb structure 20 in the cross section perpendicular to the axial direction of the honeycomb structure 20. In the honeycomb structure 20 shown in FIGS. 9 and 10, the honeycomb structure 20 is provided with a plurality of metal wires 42. The respective metal wires 42 are each formed in a ring shape so as to go around the honeycomb structure 20, and are spaced apart from each other. The metal member 41 of the honeycomb structure 20 may be provided such that one metal wire 44 spirally goes around the honeycomb structure 20, as shown in FIG. 11 (A). The honeycomb structure 20 may be provided with the metal wires 45 extending parallel to the axial direction of the honeycomb structure 20 inside the outer peripheral wall 11, as shown in FIG. 11 (B).

### <2. Method for Producing Honeycomb Structure>

The method for producing the honeycomb structure 10 will be described in detail. First, the honeycomb structure having the porous partition walls and the plurality of cells defined by the partition walls is produced. For example, when producing the honeycomb structure made of cordierite, a cordierite-forming raw material is firstly prepared as a material for a green body. The cordierite-forming raw material contains a silica source component, a magnesia source component, and an alumina source component, and the like, in order to formulate each component so as to have a theoretical composition of cordierite. Among them, the silica source component that can be used includes preferably quartz and fused silica, and the particle diameter of the silica source component is preferably from 100 to 150 μm.

Examples of the magnesia source component include talc and magnesite. Among them, talc is preferred. The talc is preferably contained in an amount of from 37 to 43% by mass in the cordierite-forming raw material. The talc preferably has a particle diameter (average particle diameter) of from 5 to 50 μm, and more preferably from 10 to 40 μm. Further, the magnesia (MgO) source component may contain Fe₂O₃, CaO, Na₂O, K₂O and the like as impurities.

The alumina source component preferably contains at least one of aluminum oxide and aluminum hydroxide, in terms of fewer impurities. Further, aluminum hydroxide is preferably contained in an amount of from 10 to 30% by mass, and aluminum oxide is preferably contained in an amount of from 0 to 20% by mass, in the cordierite-forming raw material.

A material for a green body to be added to the cordierite-forming raw material (additive) is then prepared. At least a binder and a pore former are used as additives. In addition to the binder and the pore former, a dispersant or a surfactant can be used.

The pore former that can be used includes a substance that can be oxidatively removed by reacting with oxygen at a temperature equal to or lower than a firing temperature of cordierite, or a low melting point reactant having a melting point at a temperature equal to or lower than the firing temperature of cordierite, or the like. Examples of the substance that can be oxidatively removed include resins (particularly particulate resins), graphite (particularly particulate graphite) and the like. Examples of the low melting point reactant that can be used include at least one metal selected from the group consisting of iron, copper, zinc, lead, aluminum, and nickel, alloys mainly based on those metals (e.g., carbon steel or cast iron for iron, stainless steel), or alloys mainly based on two or more of those metals. Among them, the low melting point reactant is preferably an iron alloy in the form of powder or fiber. Further, the low melting pint reactant preferably has a particle diameter or a fiber diameter (an average diameter) of from 10 to 200 μm. Examples of a shape of the low melting point reactant include a spherical shape, a wound-lozenge shape, a konpeito shape, and the like. These shapes are preferable because the shape of the pores can be easily controlled.

Examples of the binder include hydroxypropylmethyl cellulose, methyl cellulose, hydroxyethyl cellulose, carboxymethyl cellulose, polyvinyl alcohol and the like. Further, examples of the dispersant include dextrin, polyalcohol and the like. Furthermore, examples of the surfactant include fatty acid soaps. The additive may be used alone or in combination of two or more.

Subsequently, to 100 parts by mass of the cordierite-forming raw material are added from 3 to 8 parts by mass of the binder, from 3 to 40 parts by mass of the pore former, from 0.1 to 2 parts by mass of the dispersant, and from 10 to 40 parts by mass of water, and these materials for a green body are kneaded to prepare a green body.

The prepared green body is then formed into a honeycomb shape by an extrusion molding method, an injection molding method, a press molding method, or the like to obtain a raw honeycomb formed body. The extrusion molding method is preferably employed, because continuous molding is easy, and, for example, cordierite crystals can be oriented. The extrusion molding method can be performed using an apparatus such as a vacuum green body kneader, a ram type extrusion molding machine, a twin-screw type continuous extrusion molding machine, or the like.

The honeycomb formed body is then dried and adjusted to a predetermined size to obtain a honeycomb dried body. The honeycomb formed body can be dried by hot air drying, microwave drying, dielectric drying, drying under reduced pressure, vacuum drying, freeze drying and the like. It is preferable to perform combined drying of the hot air drying and the microwave drying or dielectric drying, because the entire honeycomb formed body can be rapidly and uniformly dried.

The honeycomb dried body is then fired to produce a honeycomb fired body. Each of the honeycomb fired bodies is then used as a honeycomb segment, and the sides of the honeycomb segments are joined together via the joining material layers and integrated to form a honeycomb structure with the honeycomb segments joined together. For example, the honeycomb structure with the honeycomb segments joined together can be produced as follows.

First, the joining material is applied to joining surfaces (side surfaces) of each honeycomb segment while attaching joining material adhesion preventing masks to both end faces of each honeycomb segment. These honeycomb segments are then arranged adjacent to each other such that the side surfaces of the honeycomb segments are opposed to each other, and the adjacent honeycomb segments are pressure-bonded together, and then heated and dried. Thus, the honeycomb structure in which the side surfaces of the adjacent honeycomb segments are joined via the joining material layers is produced.

The material of the joining material adhesion preventing mask that can be suitably used herein includes, but not particularly limited to, synthetic resins such as polypropylene (PP), polyethylene terephthalate (PET), polyimide, or Teflon (Registered trademark), and the like. Further, the mask is preferably provided with an adhesive layer, and the material of the adhesive layer is preferably an acrylic resin, a rubber (for example, a rubber mainly based on a natural rubber or a synthetic rubber), or a silicon resin. Examples of the joining material adhesion preventing mask that can be suitably used herein include an adhesive film having a thickness of from 20 to 50 μm.

Before joining the sides of adjacent honeycomb segments together via the joining material layers as described above, the metal member is provided in advance by wrapping the metal wire around the outer periphery of the honeycomb segment or by other means, and the joining material is then applied to the outer periphery of the honeycomb segment so as to cover the metal member, thereby producing the honeycomb structure with the metal member embedded in the joining material layer.

Further, when the resulting honeycomb structure is produced in a state where the outer peripheral wall is formed on the outer peripheral surface of the honeycomb structure, the outer peripheral surface may be ground to remove the outer peripheral wall. The coating material is applied to the outer periphery of the honeycomb structure from which the outer peripheral wall has thus been removed, in a subsequent step, to form a coating layer. Further, when grinding the outer peripheral surface, a part of the outer peripheral wall may be ground and removed, and on that part, the coating layer may be formed by the coating material.

When preparing the coating material, it can be prepared using, for example, a biaxial rotary type vertical mixer. Further, the coating material may further contain colloidal silica, an organic binder, clay and the like. The content of the organic binder is preferably from 0.05 to 0.5% by mass, and more preferably from 0.1 to 0.2% by mass. The content of the clay is preferably from 0.2 to 2.0% by mass, and more preferably from 0.4 to 0.8% by mass.

The coating material is applied onto the outer peripheral surface of the honeycomb structure, and the applied coating material is dried to form the coating layer. Such a structure can allow for effective suppression of cracking in the coating layer during the drying and the heat treatment. Also, the metal wire may be previously provided such as by wrapping the metal wire around the outer peripheral surface of the honeycomb structure, and then applying the coating material to the outer peripheral surface of the honeycomb structure so as to cover the metal member, thereby producing the honeycomb structure with the metal member embedded in the coating layer.

Examples of a method for coating the coating material can include a method for applying the coating material by placing the honeycomb structure on a rotating table and rotating it, and pressing a blade-shaped applying nozzle along the outer peripheral portion of the honeycomb structure while discharging the coating material from the applying nozzle. Such a configuration can allow the coating material to be applied with a uniform thickness. Further, this method can lead to a decreased surface roughness of the formed outer peripheral coating, and can result in an outer peripheral coating that has an improved appearance and is difficult to be broken by thermal shock.

The method for drying the applied coating material is not limited, but in terms of preventing dry-cracking, it can suitably use, for example, a method of drying 25% or more of a water content in the coating material by maintaining the coating material at room temperature for 24 hours or more, and then maintaining it in an electric furnace at 600° C. for 1 hour or more to remove moisture and organic matters.

When supporting the catalyst on the honeycomb structure, the method for supporting the catalyst is not particularly limited and it can be carried out according to the method for supporting the catalyst carried out in the conventional method for producing the honeycomb structure.

### <3. Exhaust Gas Purifying Device>

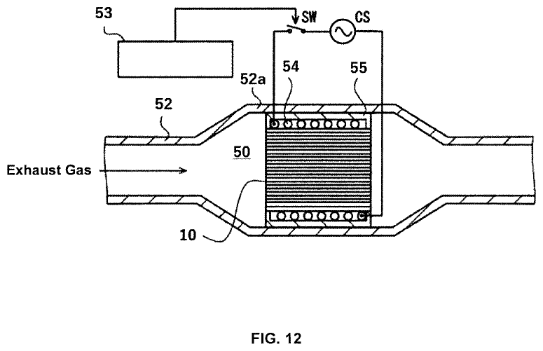

Using the honeycomb structure according to the embodiment of the present invention as described above, an exhaust gas purifying device can be formed. As an example, FIG. 12 shows a schematic view of an exhaust gas flow path of an exhaust gas purifying device 50 including the honeycomb structure 10. The exhaust gas purifying device 50 includes the honeycomb structure 10 and a coil wiring 54 that spirally surrounds the outer periphery of the honeycomb structure 10. Also, the exhaust gas purifying device 50 has a metal pipe 52 for housing the honeycomb structure 10 and the coil wiring 54. The exhaust gas purifying device 50 can be arranged in an increased diameter portion 52a of the metal pipe 52. The coil wiring 54 may be fixed to the interior of the metal pipe 52 by a fixing member 55. The fixing member 55 is preferably a heat-resistant member such as ceramic fibers. The honeycomb structure 10 may support a catalyst.

The coil wiring 54 is spirally wound around the outer periphery of the honeycomb structure 10. It is also assumed that two or more coil wirings 54 are used. An AC current supplied from an AC power supply CS flows through the coil wiring 54 in response to turning on (ON) of a switch SW, and as a result, a magnetic field that periodically changes is generated around the coil wiring 54. The on/off of the switch SW is controlled by a control unit 53. The control unit 53 can turn on the switch SW in synchronization with the start of an engine and pass an alternating current through the coil wiring 54. It is also assumed that the control unit 53 turns on the switch SW regardless of the start of the engine (for example, in response to an operation of a heating switch pushed by a driver).

In the present disclosure, a temperature of the honeycomb structure 10 is increased in response to the change of the magnetic field according to the alternating current flowing through the coil wiring 54. Based on this, carbon fine particles and the like collected by the honeycomb structure 10 are burned out. Also, when the honeycomb structure 10 supports the catalyst, the increase in the temperature of the honeycomb structure 10 raises a temperature of the catalyst supported by the catalyst support contained in the honeycomb structure 10 and promotes the catalytic reaction. Briefly, carbon monoxide (CO), nitrogen oxide (NOₓ), and hydrocarbon (CH) are oxidized or reduced to carbon dioxide (CO₂), nitrogen (N₂), and water (H₂O).

### EXAMPLES

Hereinafter, the present invention will be specifically described based on Examples. However, the present invention is not limited to Examples.

### Example 1

A pillar shaped cordierite honeycomb segment having 42 mm square, a length of 85 mm, a partition wall thickness of 0.1 mm and a distance between partition walls of about 1 mm was prepared. A metal wire having a wire diameter of 0.45 mm, which was made of the balance Fe-17% by mass of Cr, was wound around the outer peripheral surface of the honeycomb segment. Cordierite honeycomb segments which had the same size and did not wrap the metal wire were joined using the joining material to the circumference of the honeycomb segment around which the metal wire was wrapped to produce a joined body. The joining material used was a mixture of cordierite powder having an average particle diameter of 15 μm, alumina fibers having an average length of 200 μm, colloidal silica, and carboxymethyl cellulose. The honeycomb segment around which the metal wire was wrapped was used at the center of the joined body, and the outer periphery was processed to form a cylindrical shape having a diameter of 82 mm to obtain a honeycomb structure.

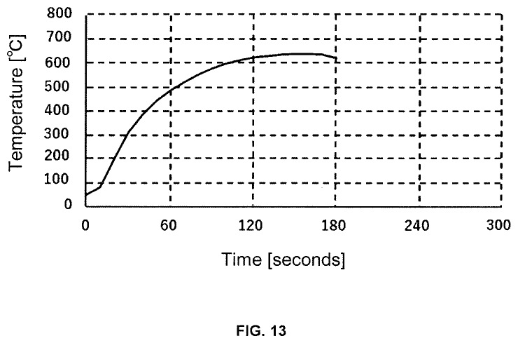

Subsequently, a heating test of the honeycomb structure was conducted with an induction heating coil having a diameter of 100 mm using an induction heating device, and a temperature of the end face of the honeycomb structure was measured with an infrared thermometer. The heating performance of the honeycomb structure was measured at an input power of 14 kW, and at an induction heating frequency of 30 kHz. FIG. 13 shows a graph showing a relationship between a time (seconds) and a temperature (° C.).

### DESCRIPTION OF REFERENCE NUMERALS

10, 20 honeycomb structure
11 outer peripheral wall
12 partition wall
15 cell
17 honeycomb segment
18 joining material layer
21, 31, 41 metal member
22, 23, 24, 25, 42, 44, 45 metal wire
32 coating layer
38, 39 plugged portion
50 exhaust gas purifying device
52 metal pipe
53 control unit
54 coil wiring
55 fixing member

1. A pillar shaped honeycomb structure comprising pillar shaped honeycomb segments joined together via joining material layers,
wherein each of the pillar shaped honeycomb segment comprises: an outer peripheral wall; and a porous partition wall disposed on an inner side of the outer peripheral wall, the partition wall defining a plurality of cells, each of the cells extending from one end face to other end face to form a flow path, and
wherein a metal member is embedded in the joining material layer.

2. The honeycomb structure according to claim 1,
wherein the pillar shaped honeycomb structure further comprises a coating layer on an outer peripheral surface of the honeycomb structure, and
wherein the metal member is disposed inside the coating layer or on a surface of the coating layer.

3. The honeycomb structure according to claim 1, wherein the metal member is a metal wire.

4. The honeycomb structure according to claim 3, wherein the metal wire is provided so as to go around an outer periphery of the honeycomb segment in the joining material layer.

5. The honeycomb structure according to claim 4, wherein the metal wire provided so as to go around the outer periphery of the pillar shaped honeycomb segment forms a loop current flow path that goes along the outer periphery of the pillar shaped honeycomb segment, in a cross section perpendicular to an axial direction of the pillar shaped honeycomb structure.

6. The honeycomb structure according to claim 3, wherein the metal wires are provided so as to extend parallel to an axial direction of the honeycomb segment in the joining material layers.

7. The honeycomb structure according to claim 1, wherein the metal member is a metal foil or a metal mesh.

8. The honeycomb structure according to claim 1, wherein the metal member is made of one or more selected from copper, iron, aluminum, nickel, chromium, and cobalt.

9. The honeycomb structure according to claim 1, wherein at least a part of the metal members comprises a magnetic substance.

10. The honeycomb structure according to claim 9, wherein all of the metal members comprise a magnetic substance.

11. The honeycomb structure according to claim 9, wherein the magnetic substance has a Curie point of 450° C. or more.

12. The honeycomb structure according to claim 9, wherein the magnetic substance has an intrinsic resistance value of 20 μΩcm or more at 25° C.

13. The honeycomb structure according to claim 9, wherein the magnetic substance has a maximum magnetic permeability of 1000 or more.

14. The honeycomb structure according to claim 1,
wherein the partition wall and the outer peripheral wall comprise a ceramic material, and
wherein the ceramic material has a thermal conductivity of 3 W/mK or more.

15. The honeycomb structure according to claim 1,
wherein the partition wall and the outer peripheral wall comprise a ceramic material, and
wherein the ceramic material has a thermal expansion coefficient of 3×10⁻⁶ or more.

16. The honeycomb structure according to claim 1,
wherein the partition wall and the outer peripheral wall comprise a ceramic material, and
wherein the ceramic material is at least one selected from cordierite, silicon carbide, silicon, aluminum titanate, silicon nitride, mullite, and alumina.

17. A pillar shaped honeycomb structure, comprising: an outer peripheral wall; and a porous partition wall disposed on an inner side of the outer peripheral wall, the partition wall defining a plurality of cells, each of the cells extending from one end face to other end face to form a flow path,
wherein a metal member is arranged inside the outer peripheral wall or on a surface of the outer peripheral wall.

18. The honeycomb structure according to claim 17,
wherein the honeycomb structure comprises pillar shaped honeycomb segments joined together via joining material layers, and
wherein each of the pillar shaped honeycomb segment comprises: an outer peripheral wall; and a porous partition wall disposed on an inner side of the outer peripheral wall, the partition wall defining a plurality of cells, each of the cells extending from one end face to other end face to form a flow path.

19. An exhaust gas purifying device, comprising:
the honeycomb structure according to claim 1;
a coil wiring that spirally surrounds an outer periphery of the honeycomb structure; and
a metal pipe for housing the honeycomb structure and the coil wiring.
